(19) United States
(12) Patent Application Publication
(10) Pub. No.: US 2016/0052462 A1
(43) Pub. Date: Feb. 25, 2016

(54) SYSTEMS AND METHODS RELATED TO GOLF ACCESSORY SUPPORT

(71) Applicant: KURT J. HEILGENDORF, Germantown, WI (US)

(72) Inventor: KURT J. HEILGENDORF, Germantown, WI (US)

(21) Appl. No.: 14/833,612

(22) Filed: Aug. 24, 2015

Related U.S. Application Data
(60) Provisional application No. 62/040,527, filed on Aug. 22, 2014.

(51) Int. Cl. B60R 9/08

(52) U.S. Cl. CPC B60R 9/08; B60R 2011/004

(57) ABSTRACT

A support for golf accessories includes a magnet. The support may further include a hook-or-loop fastening member disposed opposite the magnet, or a support aperture for receiving accessories mateable therewith. Accessories to be supported include anything with a loop-or-hook material thereon, or secured with such strap. Additionally or alternatively, accessories may include a cigar holder, a tee holder, a hook-or-loop disk, and/or a golf ball holder. A method of drying a clothing article includes attaching the clothing article, such as a golf glove, to a human transport vehicle, such as a golf cart, and then moving the vehicle to cause environmental air to flow around and/or into the clothing article.

### RELATED APPLICATIONS

This application claims the benefit of co-pending U.S. Provisional Patent Application Ser. No. 62/040,527, filed 22 Aug. 2014, and titled, “Systems and Methods Related to Golf Accessory Support.”

### BACKGROUND OF THE INVENTION

Embodiments according to the present invention relate generally to organization, and more particularly to organization and maintenance of accessories for the sport of golf.

The sport of golf is most often played in warm weather, and may be played in inclement weather. A golfer may utilize a glove, often made of leather or a synthetic material, during or for at least a portion of golf play. On an average golf hole, a player utilizes a plurality of golf clubs, each used to, in theory, impart a different trajectory and/or distance to a golf ball when struck. Many golfers, when using a club selected for short distance and/or high trajectory, remove their golf glove(s). Often times the removed glove is placed in a pocket or compartment in a golf cart.

When golfing in warm or inclement weather, it is common for a golf glove to become wet during use. In the first instance, perspiration from the golfer may wick into the glove from the golfer's body. In the second instance, the glove may be exposed to environmental moisture, such as rain or condensation from a beverage container, in which case the moisture is provided from a source external to the glove. In either case, it may be of interest to effectuate a drying of the golf glove so as to improve comfort and/or grip cooperation with a golf club.

### SUMMARY OF THE INVENTION

Systems and methods according to the present invention may be utilized to effectuate a drying of the golf glove so as to improve comfort and/or grip cooperation with a golf club. Systems and methods according to the present invention may also be utilized to support golf accessories, such as tees, gloves, balls, or even cigars.

One aspect of the invention provides a support for golf accessories removably attachable to a support member of a golf cart that includes an accessory support comprising a ring magnet and a cylindrical housing with an open end and a closed end, wherein the ring magnet is secured within the open end of the cylindrical housing, and the accessory support is configured to be removably secured to the support member of the golf cart, and an accessory holder configured to be removably affixed to the accessory support.

The accessory support may further comprise a first coupling member with a front surface and a rear surface; wherein the rear surface has an adhesive thereon to adhere to the closed end of the cylindrical housing and the front surface comprises hook or loop material.

The accessory holder may also have an anchor with a coupling surface comprising hook or loop material configured to cooperate with the hook or loop material on the front surface of the accessory support.

Additionally, the ring magnet may have an aperture and the closed end of the cylindrical housing has an aperture; whereby the aperture in the ring magnet is larger than the aperture in the closed end of the cylindrical housing.

The accessory holder may have an anchor with an arrowhead fastener configured to be received within the aperture of the closed end and the aperture of the ring magnet and supported by the closed end of the cylindrical housing. The accessory holder may further comprise a plate with a front side and a rear side, whereby the anchor protrudes from the rear side and the front side has hook or loop material provided thereon. The plate may be shaped like a hand.

Additionally or alternatively, the accessory holder may be a curviplanar shelf, a plate member with a plurality of holes configured to receive and support golf Lees, or a cylindrical tube configured to house and dispense golf balls, the cylindrical tube having a cylindrical wall, an open top end opposite a closed bottom end, and an access opening formed through the cylindrical wall and located closer to the closed end than the open end.

Another aspect of the invention provides a support system for golf accessories removably attachable to a support member of a golf cart including at least one accessory support with a ring magnet and a cylindrical housing with an open end and a closed end, wherein the ring magnet is secured within the open end of the cylindrical housing, and the accessory support is configured to be removably secured to the support member of the golf cart; a plurality of accessory holders configured to be removably affixed to the accessory support; and a tray with compartments sized and configured to house the at least one accessory support and the plurality of accessory holders.

The at least one accessory support may further include a first coupling member with a front surface and a rear surface; wherein the rear surface has an adhesive thereon to adhere to the closed end of the cylindrical housing and the front surface comprises hook or loop material.

Additionally or alternatively, each of the plurality of accessory holders may have an anchor, the anchor having a coupling surface comprising hook or loop material configured to cooperate with the hook or loop material on the front surface of the at least one accessory support.

The ring magnet of the support system may have an aperture and the closed end of the cylindrical housing has an aperture; whereby the aperture in the ring magnet is larger than the aperture in the closed end of the cylindrical housing.

Further, each of the plurality of accessory holders may have an anchor, the anchor having an arrowhead fastener configured to be received within the aperture of the closed end and the aperture of the ring magnet and supported by the closed end of the cylindrical housing.

The at least one of the plurality of accessory holders may include a plate with a front side and a rear side with the anchor protruding from the rear side and the front side having hook or loop material provided thereon. The plate may be shaped like a hand.

Additionally or alternatively, the at least one of the plurality of accessory holders may be a curviplanar shelf, a plate member with a plurality of holes configured to receive and support golf tees, or a cylindrical tube configured to house and dispense golf balls, the cylindrical tube having a cylindrical wall, an open top end opposite a closed bottom end, and an access opening formed through the cylindrical wall and located closer to the closed end than the open end.

### BRIEF DESCRIPTION OF THE DRAWINGS

FIG. 1A is a perspective view of a common golf cart orientation, further including a first embodiment of an accessory holder according to the present invention.

FIG. 1B is a close-up view of the accessory holder of FIG. 1A.

FIG. 2 is a partial assembly view of the accessory holder of FIG. 1A.

FIG. 3 is a perspective view of the accessory holder of FIG. 1A.

FIG. 4 is a top view of the accessory holder of FIG. 3.

FIG. 5 is a bottom view of the accessory holder of FIG. 3.

FIG. 6 is a side elevation view of the accessory holder of FIG. 3, to which all side elevation views are identical.

FIG. 7 is a top view of a second embodiment of an accessory holder according to the present invention.

FIG. 8 is a partial assembly view of a first accessory according to the present invention interfacing with the accessory holder of FIG. 3.

FIG. 9 is a partial assembly view of an alternate first accessory according to the present invention interfacing with the accessory holder of FIG. 11.

FIG. 10 is a partial assembly view of a second accessory according to the present invention interfacing with the accessory holder of FIG. 3.

FIG. 11 is a partial assembly view of a third embodiment of an accessory according to the present invention interfacing with a third embodiment of an accessory holder according to the present invention.

FIG. 12 is a partial assembly view of a fourth embodiment of an accessory according to the present invention interfacing with a plurality of accessory holders of FIG. 3.

FIG. 13 is a perspective view of a fifth embodiment of an accessory according to the present invention.

FIG. 14 is a cross-sectional, partial assembly view taken along line 14-14 of FIG. 13.

FIG. 15 is a perspective view of a first alternate fifth embodiment of an accessory according to the present invention.

FIG. 16 is a rear perspective view of the embodiment of FIG. 15.

FIG. 17 is a front side elevation view of the embodiment of FIG. 15.

FIG. 18 is a rear side elevation view of the embodiment of FIG. 15.

FIG. 19 is a left side elevation view of the embodiment of FIG. 15.

FIG. 20 is a right side elevation view of the embodiment of FIG. 15.

FIG. 21 is a top plan view of the embodiment of FIG. 15.

FIG. 22 is a bottom plan view of the embodiment of FIG. 15.

FIG. 23 is a perspective view of a second alternate fifth embodiment of an accessory according to the present invention.

FIG. 24 is a rear perspective view of the embodiment of FIG. 23.

FIG. 25 is a front side elevation view of the embodiment of FIG. 23.

FIG. 26 is a rear side elevation view of the embodiment of FIG. 23.

FIG. 27 is a left side elevation view of the embodiment of FIG. 23.

FIG. 28 is a right side elevation view of the embodiment of FIG. 23.

FIG. 29 is a top plan view of the embodiment of FIG. 23.

FIG. 30 is a bottom plan view of the embodiment of FIG. 23.

FIG. 31 is a perspective view of a third alternate fifth embodiment of an accessory holder according to the present invention.

FIG. 32 is a rear perspective view of the embodiment of FIG. 31.

FIG. 33 is a front side elevation view of the embodiment of FIG. 31.

FIG. 34 is a rear side elevation view of the embodiment of FIG. 31.

FIG. 35 is a left side elevation view of the embodiment of FIG. 31.

FIG. 36 is a right side elevation view of the embodiment of FIG. 31.

FIG. 37 is a top plan view of the embodiment of FIG. 31.

FIG. 38 is a bottom plan view of the embodiment of FIG. 31.

FIG. 39 is a diagrammatic representation of a method according to the present invention.

FIG. 40 is a top plan view of a first embodiment of a golf accessory kit according to the present invention.

FIG. 41 is a top plan view of a second embodiment of a golf accessory kit according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

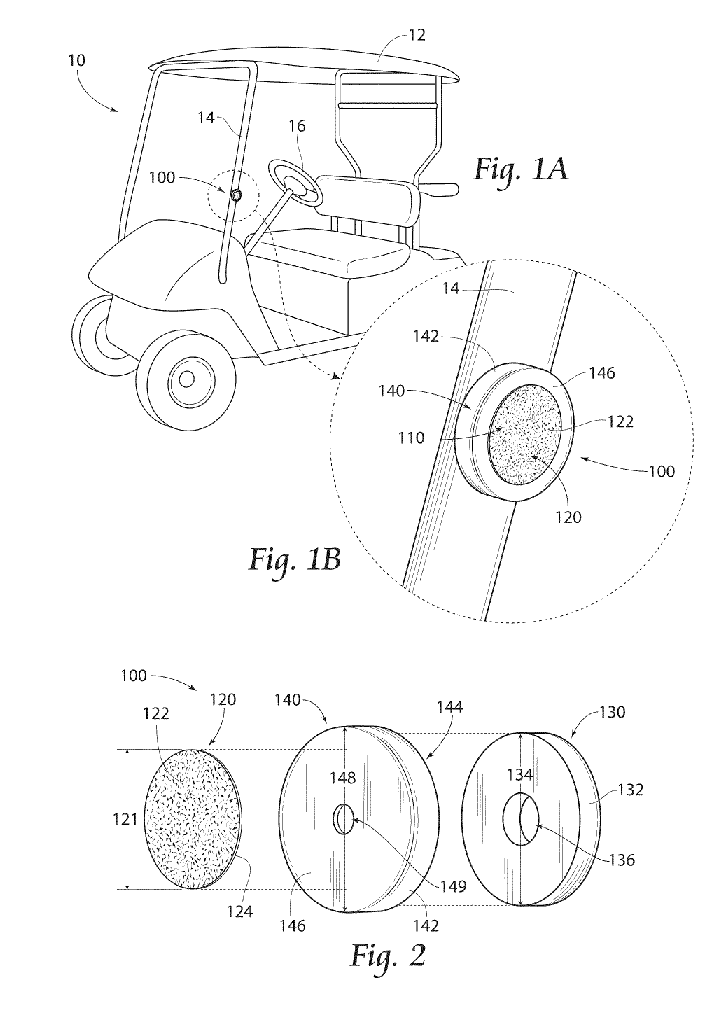

Referring now to the figures, FIG. 1A depicts a common golf cart 10 having a roof 12 supported by a plurality of support members 14. Coupled to a support member 14, preferably at least the support member 14 closest to a steering wheel 16 of the cart 10, is a first embodiment 100 of a golf accessory holder. Generally, and with reference also to FIGS. 1B and 2, the holder 100 provides an anchor point 110, which is easily mounted to and removable from the support member 14. In this embodiment 100, the anchor point 110 is provided by a first coupling member 120, which may be easily mounted to and removed from the support member 14 by a second coupling member 130. An intermediate coupling member 140 may be provided to interface between the first coupling member 120 and the second coupling member 130.

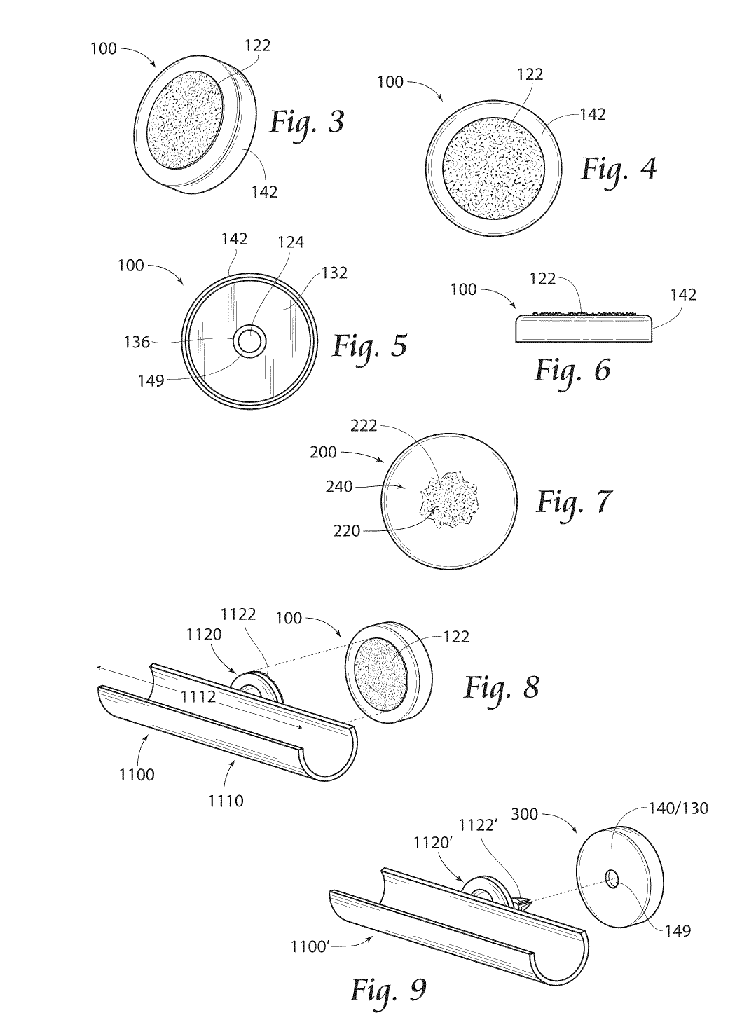

The first coupling member 120 is preferably formed in a desired shape (e.g. a circle having a first diameter 121) from a sheet of hook-and-loop material having hooks or loops on a front surface 122 and having adhesive on a rear surface 124. The second coupling member 130 is preferably a ring magnet 132 having a second diameter 134, which may be larger than the first diameter 121, and an aperture 136 formed coaxially therethrough. The intermediate coupling member 140 may be a generally cylindrical housing 142 having an open end 144 and a closed end 146. The housing 142 has a third diameter 148 that is preferably larger than the second diameter 134. The closed end 146 may include an intermediate aperture 149, which may be smaller than the magnet aperture 136. The second coupling member 130 and the intermediate coupling member 140 may be provided as a flat pot magnet (also known in the art as a gripper magnet or holding magnet). Thus, the magnet 132 may be inserted through the open end 144 of the housing 142 and adhered therein, such as with glue. The rear surface 124 of the first coupling member 120 may be adhered to the closed end 146 of the housing 142, thereby coupling the first coupling member 120 to the second 130. Alternatively, the intermediate housing 140 may be eliminated, and the first coupling member 120 may be adhered directly to the second coupling member 130. FIGS. 3-6 provide different views of the first embodiment 100 of an accessory holder according to the present invention.

FIG. 7 depicts a second embodiment 200 of an accessory holder according to the present invention, where similar reference numerals refer to identical or similar structure to that of the first embodiment 100. This embodiment 200 includes a first coupling member 220 that has a hook or loop surface 222 of an undefined shape. That is, it could be of any shape, so long as there is a hook or loop surface 222 included, preferably mounted to an intermediate coupling member 240.

FIG. 8 provides a first accessory 1100 which may be supported by an accessory holder according to the present invention, such as the first embodiment 100. This accessory 1100 includes a partially cylindrical or otherwise preferably curviplanar shelf 1110 and an anchor 1120. The shelf 1110 extends along a shelf length 1112 and may be intended to provide a substantially horizontal space to rest an object (e.g. a cigar) when the accessory support 100 is coupled to a support member 14. The anchor 1120 preferably mates with an embodiment of an accessory support according to the present invention. For instance, in FIG. 8, the accessory 1100 is shown as being mateable with the first embodiment. 100 of an accessory support. In this fashion, the anchor 1120 of the accessory 1100 has a coupling surface 1122, which is loop or hook material adapted to cooperate with the hook or loop material on the front surface 122 on the accessory support 100. In FIG. 9, the accessory support has been provided as a third accessory support 300 preferably comprising the secondary coupling member 130 secured within the intermediate coupling member 140. In this embodiment, the apertures 136 and 149 provide an anchor point for cooperating structure provided on an accessory (e.g. accessory 1100′). This accessory 1100′ includes an anchor 1120′, which has an arrowhead fastener 1122′ adapted to be inserted into the aperture 149 and supported thereby. The anchor 1120′ may include a gasket material (not shown) so as to maintain the relative orientation of the support 300 and the accessory 1100′.

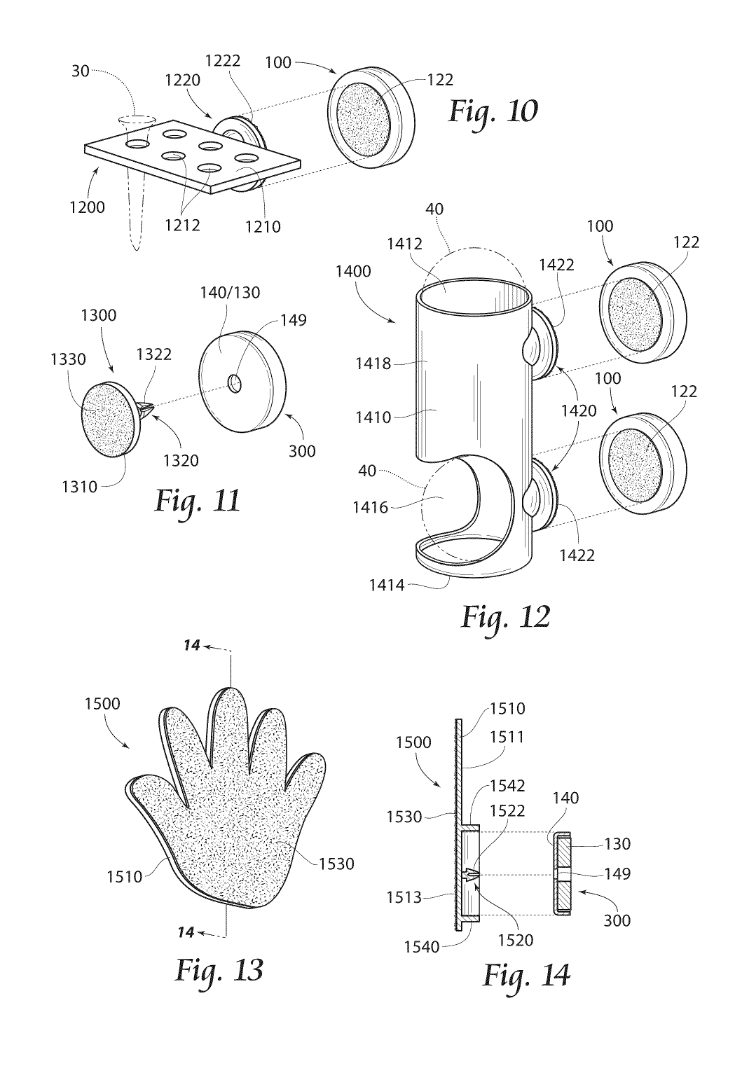

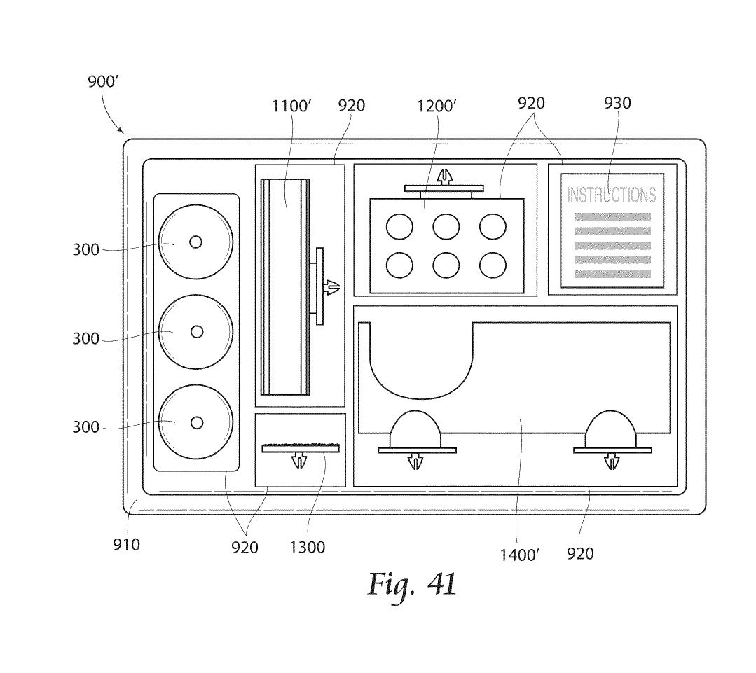

FIG. 10 provides a tee holder accessory 1200, including a support structure which may be of any functional shape, such as a plate member 1210 as shown, including a plurality of apertures 1212 into each of which a golf tee 30 may be received. The apertures 1212 may extend completely through the support structure, or they may be formed as reentrant bores into the structure. The apertures 1212 may allow a golf tee 30 to freely slide in and out of the aperture, or the apertures 1212 may frictionally engage the golf tee 30 along a majority of a length of the tee 30. This accessory 1200, like the former 1100, has an anchor 1220, which preferably mates with an embodiment of an accessory support according to the present invention. For instance, in FIG. 10, the accessory 1200 is shown as being mateable with the first embodiment 100 of an accessory support. In this fashion, the anchor 1220 of the accessory 1200 has a coupling surface 1222, which is loop or hook material adapted to cooperate with the hook or loop material on the front surface 122 of the accessory support 100. Though not shown, a second embodiment tee holder accessory 1200′ may be coupled to an accessory support 300, in a manner as previously described with respect to the first accessory 1100 (see FIG. 41).

FIG. 11 depicts a third embodiment 1300 of an accessory according to the present invention, which is mateable with a third embodiment 300 of an accessory support according to the present invention. As stated above, the third accessory support 300 preferably comprises a pot magnet including the ring magnet 132 secured within the cylindrical housing 142. This accessory 1300 preferably includes a disk 1310 of material such as plastic. The disk 1310 has an anchor 1320 on its rear side, which preferably includes an arrowhead fastener 1322 adapted to snap into the aperture 149 provided on the support 300. The anchor 1320 may include a gasket material (not shown) so as to maintain the relative orientation of the support 300 and the accessory 1300. On its front side, the disk 1310 preferably includes a hook or loop material 1330, which may serve generally the same function as the hook or loop material provided on the front surface 122 of the first embodiment 100 of the accessory support.

FIG. 12 depicts a fourth embodiment 1400 of an accessory according to the present invention, which is mateable with a plurality of accessory supports according to the present invention, such as support 100. This accessory is provided generally as a holder for golf balls 40, the holder being in the form of a cylindrical tube 1410 coupled to a plurality of anchors 1420. The tube 1410 extends between an open Lop end 1412 and a closed bottom end 1414. Located along the longitudinal length of the tube 1410, preferably closer to the closed end 1414 than the open end 1412, is an access opening 1416 formed through a cylindrical wall 1418, which generally forms the tube 1410. The opening 1416 is sized so as to maintain a golf ball 40 within the tube 1410 under rest conditions (i.e. absent outside physical force being placed on a ball 40), but allows a ball 40 to be withdrawn therethrough when a radial withdrawal force is applied to a ball 40, which may be situated against the closed end 1414. The anchors 1420 preferably each have a coupling surface 1422, which is loop or hook material adapted to cooperate with the hook or loop material on the front surface 122 of the accessory support 100. Though not shown, a second embodiment of the golf ball holder accessory 1400′ may be coupled to a plurality of accessory supports 300, each coupling being in a manner as previously described with respect to the first accessory 1100 (see FIG. 41).

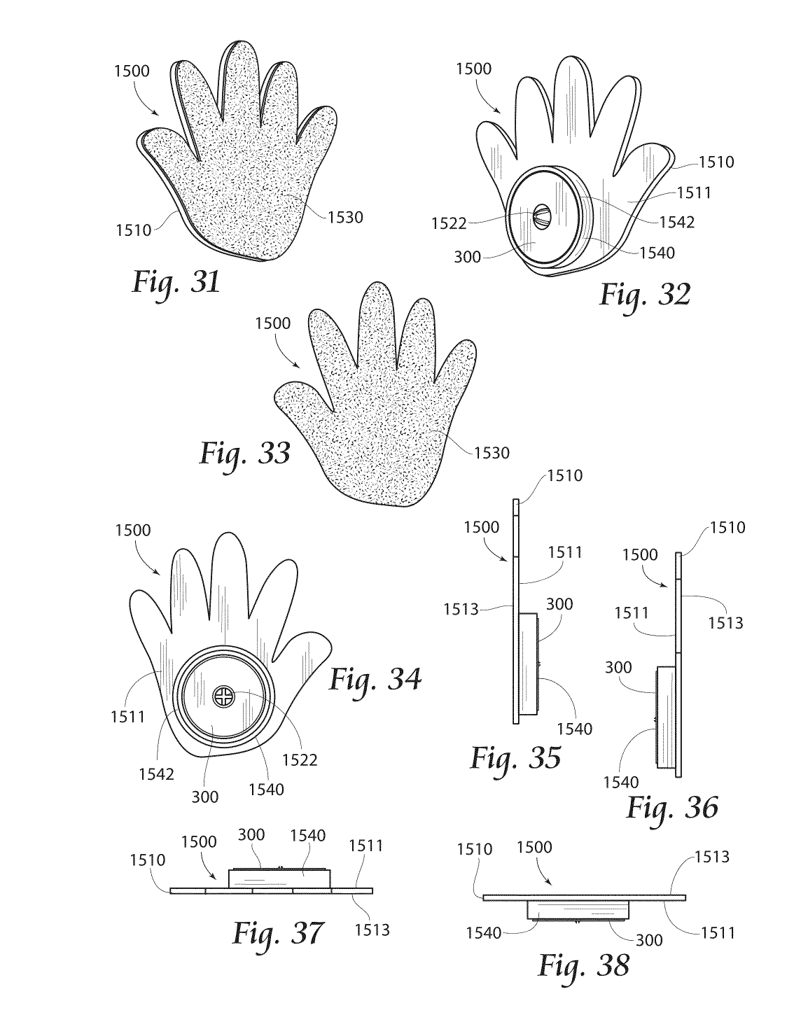

FIGS. 13-14 and 31-38 show a fifth embodiment of an accessory according to the present invention. This embodiment 1500 is similar to the third accessory 1300, but provided in the shape of a hand or in some other non-geometric decorative shape. Accordingly, the accessory 1500 is generally mateable with the third embodiment 300 of an accessory support according to the present invention. As stated above, the third accessory support 300 preferably comprises a pot magnet including the ring magnet 132 secured within the cylindrical housing 142. This accessory 1500 preferably includes a plate 1510 of material such as plastic. The plate 1510 has an anchor 1520 on its rear side 1511, which preferably includes an arrowhead fastener 1522 adapted to snap into the aperture 149 provided on the support 300. The anchor 1520 may include a gasket material (not shown) so as to maintain the relative orientation of the support 300 and the accessory 1500. On its front side 1513, the plate 1510 preferably includes a hook or loop material 1530, which may serve generally the same function as the hook or loop material provided on the front surface 122 of the first embodiment 100 of the accessory support. The accessory 1500 may further include a mount receiver 1540, which may be configured to receive the second mounting structure 130 and/or the intermediate mounting structure 140, such as the pot magnet 300. The receiver 1540 may include a circumferential wall 1542 disposed around the anchor 1520.

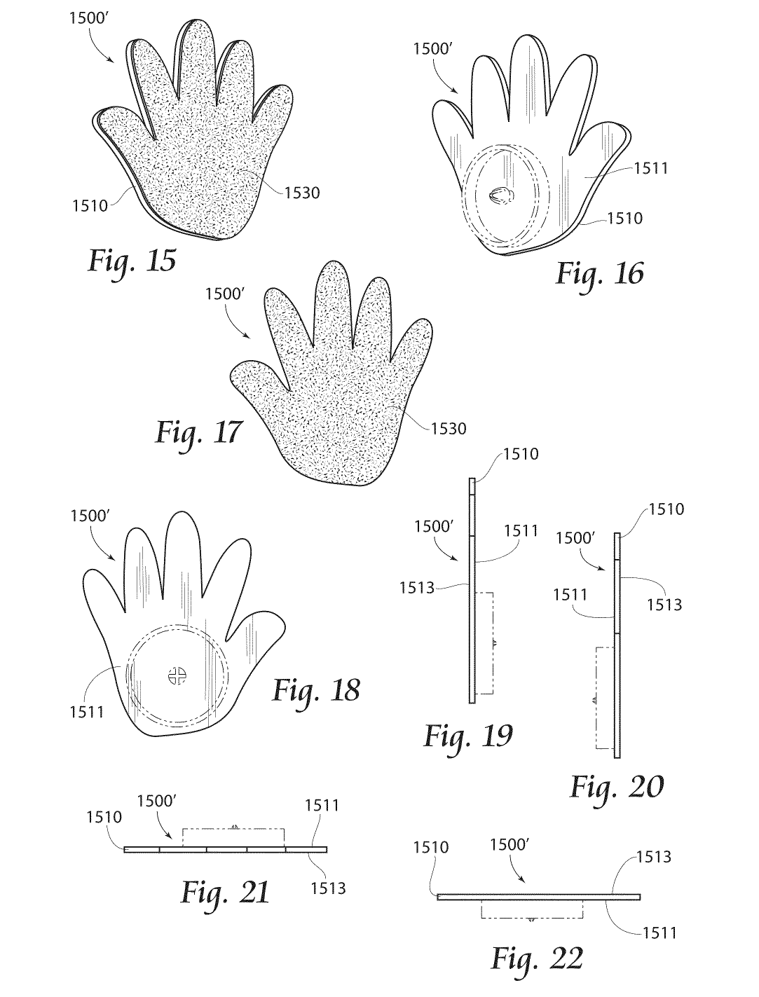

FIGS. 15-22 provide the indicated views of an embodiment of the fifth accessory 1500′, but without the anchor 1520 or the mount receiver 1540, thus providing a plate member 1510 that may be adhered to or incorporated within a support structure.

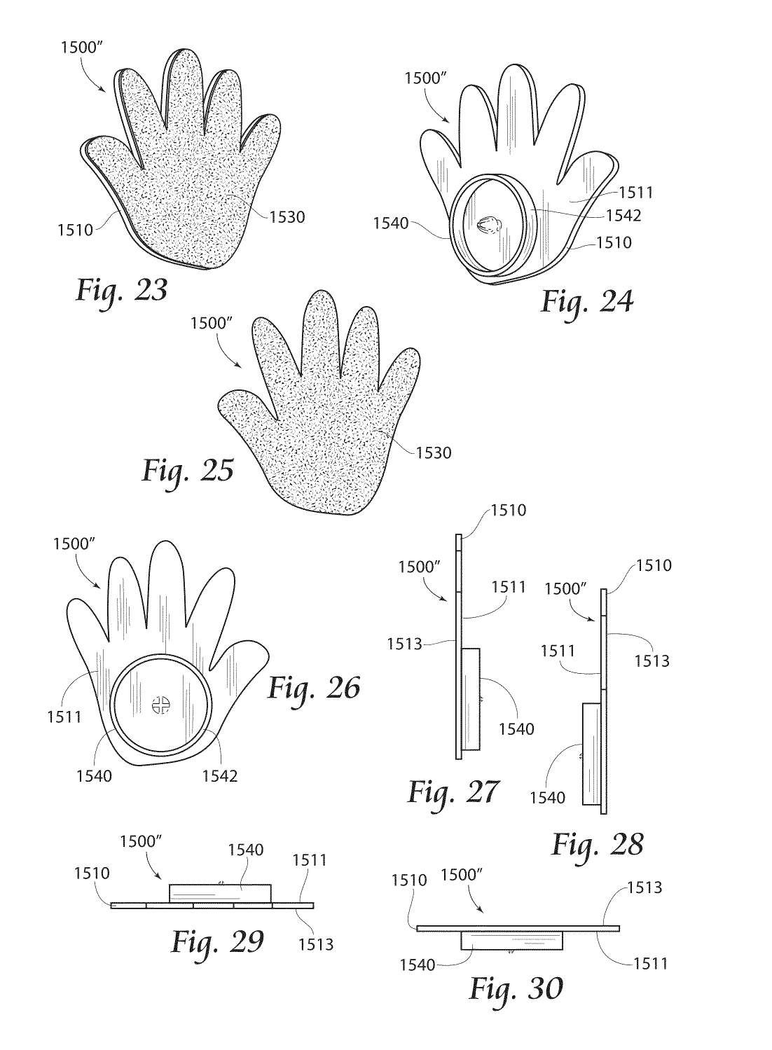

FIGS. 23-30 provide the indicated views of an embodiment of the fifth accessory 1500″, but without the anchor 1520 and with the mount receiver 1540. In this manner, a pot magnet 300 may be received within the mount receiver 1540 and secured therein, such as with an adhesive.

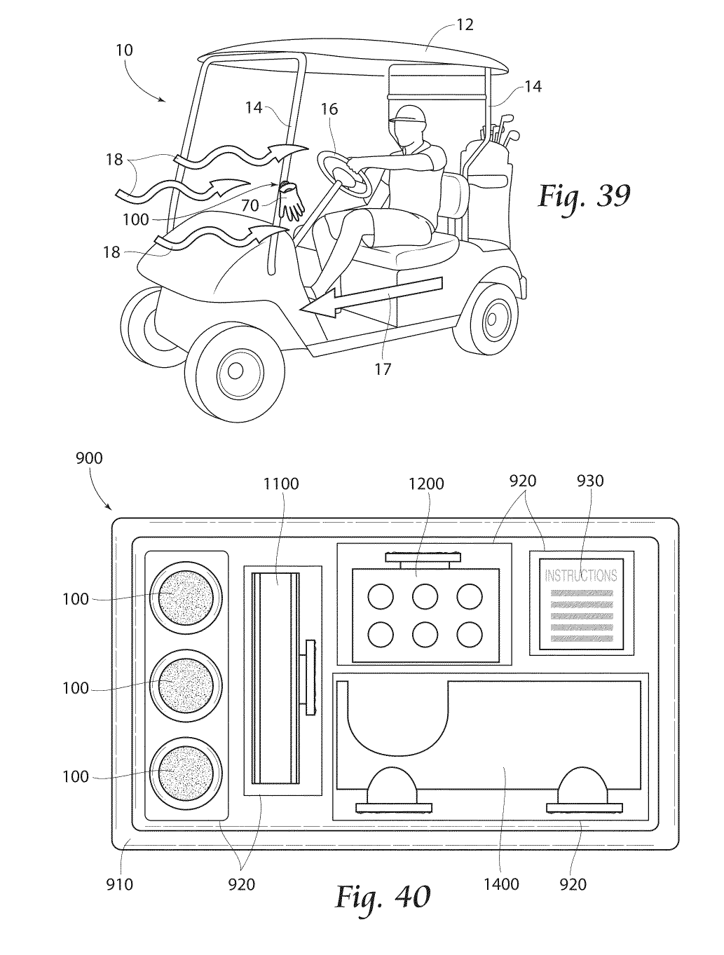

Also according to the present invention is a method of drying a clothing article by securing the article to a human transport vehicle and then moving that vehicle to allow ambient airflow around and/or through the clothing article. FIG. 39 diagrammatically depicts a method of drying a clothing article according to the present invention. As shown, a golf glove 70 has been coupled to a golf cart 10 having a roof 12 supported by support members 14 through the use of an accessory support 100 according to the present invention. That is, the ring magnet 132 is attracted to the composition of the support member 14, which is commonly a magnetic material. While a positioning of an accessory support 100 nearest the steering wheel 16 may be advantageous, it is to be understood that the accessory support 100 could be mounted to any suitable surface, such as any suitable magnetic surface, on a moving vehicle, such as a golf cart 10.

The accessory in this depiction is the golf glove 70. Golf gloves 70 typically have hook and loop closures at the wrist end of the glove. Thus, the glove 70 has been removed from a human hand, and secured to the accessory holder 100, preferably with the wrist end of the glove aimed at least partially, and preferably substantially, in a forward direction 17. The golf cart 10 is moved in the forward direction 17, thereby causing environmental air 18 to flow around and into the glove 70 to reduce a moisture thereon or therein. Such drying process may occur along any distance, but may advantageously occur along a length of one or more hole layouts on a golf course, after a golfer has utilized a first golf club having a first loft, prior to using a second golf club having a second loft, wherein the second loft is different than the first loft, preferably less than the first loft (e.g., first loft as seven iron (e.g. 34 degrees), second loft as putter (e.g. zero degrees) or driver (e.g. 10.5 degrees)) or greater than the first loft (e.g., first loft as seven iron (e.g. 34 degrees), second loft as lob wedge (e.g. 60 degrees)).

FIG. 40 provides a first embodiment 900 of an accessory and accessory support kit according to the present invention. Generally, the kit 900 includes one or more accessory supports 100 and one or more accessories, such as the cigar holder 1100, the tee holder 1200, the hook-or-loop disk 1300, the ball holder 1400, or the loop-or-hook hand 1500′ (not shown, but having a loop-or-hook anchor 1520′), the accessories in this kit 900 having a loop-or-hook anchor to cooperate with the hook-or-loop surface 122 on the supports 100. The kit 900 may generally be packaged in a tray 910 having one or more compartments 920 to contain included components. The kit 900 may further include instructions 930 for using the components, and/or for undertaking one or more methods described herein, such as a method for drying a clothing article. The tray 910 may be a vacuum or thermo-formed tray, which may be sealed or covered.

FIG. 41 provides a second embodiment 900′ of an accessory and accessory support kit according to the present invention. Generally, the kit 900′ includes one or more accessory supports 300 and one or more accessories, such as the cigar holder 1100′, the tee holder 1200′, the hook-or-loop disk 1300′, the ball holder 1400′, or the hook-or-loop hand 1500, the accessories in this kit 900′ having an arrowhead anchor to cooperate with the throughhole 149 in the supports 300. The kit 900′ may generally be packaged in a tray 910 having one or more compartments 920 to contain included components. The kit 900′ may further include instructions 930 for using the components, and/or for undertaking one or more methods described herein, such as a method for drying a clothing article. The tray 910 may be a vacuum or thermo-formed tray, which may be sealed or covered.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A support for golf accessories removably attachable to a support member of a golf cart, the support comprising:
an accessory support comprising a ring magnet and a cylindrical housing with an open end and a closed end, wherein the ring magnet is secured within the open end of the cylindrical housing, and the accessory support is configured to be removably secured to the support member of the golf cart; and
an accessory holder configured to be removably affixed to the accessory support.

2. The support according to claim 1, wherein the accessory support further comprises:
a first coupling member with a front surface and a rear surface; and
wherein the rear surface has an adhesive thereon to adhere to the closed end of the cylindrical housing and the front surface comprises hook or loop material.

3. The support according to claim 2, wherein the accessory holder has an anchor, the anchor having a coupling surface comprising hook or loop material configured to cooperate with the hook or loop material on the front surface of the accessory support.

4. The support according to claim 1, wherein the ring magnet has an aperture and the closed end of the cylindrical housing has an aperture; and
whereby the aperture in the ring magnet is larger than the aperture in the closed end of the cylindrical housing.

5. The support according to claim 4, wherein the accessory holder has an anchor, the anchor has an arrowhead fastener configured to be received within the aperture of the closed end and the aperture of the ring magnet and supported by the closed end of the cylindrical housing.

6. The accessory holder according to claim 5 further comprises a plate with a front side and a rear side;
the anchor protruding from the rear side; and
the front side has hook or loop material provided thereon.

7. The accessory holder according to claim 6, wherein the plate is shaped like a hand.

8. The support according to claim 1, wherein the accessory holder comprises a curviplanar shelf.

9. The support according to claim 1, wherein the accessory holder comprises a plate member with a plurality of holes configured to receive and support golf tees.

10. The support according to claim 1, wherein the accessory holder comprises a cylindrical tube configured to house and dispense golf balls, the cylindrical tube having a cylindrical wall, an open top end opposite a closed bottom end, and an access opening formed through the cylindrical wall and located closer to the closed end than the open end.

11. A support system for golf accessories removably attachable to a support member of a golf cart, the support system comprising:
at least one accessory support comprising a ring magnet and a cylindrical housing with an open end and a closed end, wherein the ring magnet is secured within the open end of the cylindrical housing, and the accessory support is configured to be removably secured to the support member of the golf cart;
a plurality of accessory holders configured to be removably affixed to the accessory support; and
a tray with compartments sized and configured to house the at least one accessory support and the plurality of accessory holders.

12. The support system according to claim 11, wherein the at least one accessory support further comprises:
a first coupling member with a front surface and a rear surface; and
wherein the rear surface has an adhesive thereon to adhere to the closed end of the cylindrical housing and the front surface comprises hook or loop material.

13. The support system according to claim 12, wherein each of the plurality of accessory holders has an anchor, the anchor having a coupling surface comprising hook or loop material configured to cooperate with the hook or loop material on the front surface of the at least one accessory support.

14. The support system according to claim 11, wherein the ring magnet has an aperture and the closed end of the cylindrical housing has an aperture; and
whereby the aperture in the ring magnet is larger than the aperture in the closed end of the cylindrical housing.

15. The support system according to claim 14, wherein each of the plurality of accessory holders has an anchor, the anchor has an arrowhead fastener configured to be received within the aperture of the closed end and the aperture of the ring magnet and supported by the closed end of the cylindrical housing.

16. The support system according to claim 15, wherein at least one of the plurality of accessory holders further comprises a plate with a front side and a rear side;
the anchor protruding from the rear side; and
the front side has hook or loop material provided thereon.

17. The support system according to claim 16, wherein the plate is shaped like a hand.

18. The support system according to claim 11, wherein at least one of the plurality of accessory holders comprises a curviplanar shelf.

19. The support system according to claim 11, wherein at least one of the plurality of accessory holders comprises a plate member with a plurality of holes configured to receive and support golf tees.

20. The support system according to claim 11, wherein at least one of the plurality of accessory holders comprises a cylindrical tube configured to house and dispense golf balls, the cylindrical tube having a cylindrical wall, an open top end opposite a closed bottom end, and an access opening formed through the cylindrical wall and located closer to the closed end than the open end.
